(19) United States
(12) Patent Application Publication
(10) Pub. No.: US 2007/0216116 A1
(43) Pub. Date: Sep. 20, 2007

(54) Convertible cart

(76) Inventors: Mark E. Gallea, Waseca, MN (US); Michael D. Jines, Northfield, MN (US); Matt Loftus, Waseca, MN (US); Gregg S. Nelson, Northfield, MN (US); Marty L. Prins, Owatonna, MN (US); Craig J. Ulrich, Owatonna, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/725,136

(22) Filed: Mar. 16, 2007

Related U.S. Application Data
(60) Provisional application No. 60/783,321, filed on Mar. 16, 2006.

(51) Int. Cl. B62B 11/00

(52) U.S. Cl. 280/47.36

(57) ABSTRACT

A convertible cart readily convertible between a cart configuration and a table configuration. A leg coupled to each end of the convertible cart is shiftable between a ground-clearing position as a cart and a ground-engaging position as a table. A coupling mechanism couples the leg to a chassis and includes a locking element and a coupling member with two gravity seats. To shift between a cart configuration and a table configuration, the locking element is disengaged from the first gravity seat, the leg is rotated between the ground-clearing position and the ground-engaging position, and the locking element is engaged with the second gravity seat.

### RELATED APPLICATION

This application claims the benefit of U.S. Provisional Application No. 60/783,321, entitled “CONVERTIBLE CART,” filed Mar. 16, 2006, which is incorporated herein by reference in its entirety.

### FIELD OF THE INVENTION

The present invention generally relates to a utility cart. More specifically, the present invention relates to a mobile cart convertible to a table.

### BACKGROUND OF THE INVENTION

The use of carts for transporting goods and equipment is well-known. In certain situations, it is advantageous to have a cart that is readily convertible to a table, so that once goods are transported to a location and unloaded, the cart can be converted and used as a table.

Particularly for athletic events, carts are useful for transporting equipment to a playing field for a practice or event. Once the equipment has been unloaded from the cart and practice or an event has begun, it is desirable to have a surface available for players to sit or rest upon, or to receive medical attention upon. Currently available carts that are convertible to tables are not structurally robust enough to support players or other heavy objects. Additionally, it is desirable to have table surfaces for use by athletes, coaches, and other personnel for temporarily placing items thereupon.

Often times, a separate cart and table are required to accommodate variable types of surfaces. Alternatively, some convertible carts must be disassembled and reassembled to accomplish conversion between a cart and a table, which can require multiple persons and/or increased amounts of time. In addition, these carts often require the use of multiple free small parts, such as screws, nuts, and bolts that can easily be lost, particularly in outdoor environments involving grass, dirt, and the like. Tools also may be needed to assemble and disassemble the cart.

U.S. Pat. Nos. 4,284,286, 4,565,382, 5,092,615, 5,201,536, 5,536,034, 5,653,457, 5,687,978, 5,857,695, 6,152,462, and 6,446,981 each describe carts that are convertible to tables, and are each hereby incorporated by reference. However, these patents fail to provide a cart that is readily converted to a table that also provides superior stability in either a cart configuration or a table configuration, especially for use in athletic situations. Some of these carts also require multiple persons to complete the conversion.

There remains a need for an improved convertible cart that is readily changeable from a cart to a table and vice versa without the need for removable parts. In addition, the convertible cart should be capable of converting between the cart and the table without the need for disassembling and reassembling the convertible cart, or without the need for tools.

### SUMMARY OF THE INVENTION

The convertible cart of the present invention overcomes the deficiencies of other convertible carts known in the art. The convertible cart of the present invention is particularly well suited for storage and transportation of athletic and like equipment, and can be readily converted to a table suitable for use at athletic and similar events. This should not be considered to be limiting, however. The inventive cart can be converted from a cart configuration to a table configuration without the use of removable retainers, latches, or complicated locking mechanisms and without the need for disassembling and reassembling the cart.

The convertible cart can generally include a chassis, a support surface carried by the chassis, ground engaging wheels, and legs shiftable between ground clearing and ground engaging positions, and a coupling mechanism to accomplish a static lock of the legs in either of their two positions.

In an example embodiment of the invention, the coupling mechanism includes a coupling member, a locking element and a bracket for coupling the coupling member to the chassis. The coupling member can further comprise an elongated slot and a gravity seat located adjacent each end of the elongated slot.

In one aspect of the invention, the locking element is carried in static relation to the chassis in which the locking element engages the first gravity seat when the legs are shifted in a ground clearing engaging position, and engages the second gravity seat when the legs are shifted in a ground engaging position.

In another aspect of the invention, a pivot element is carried in static relation to the chassis and is slidingly engageable in the slot of the coupling member so that the legs are shiftable between a ground clearing position and a ground engaging position without the need to remove the pivot element or locking element.

In an additional embodiment of the invention, a method of converting the convertible cart between a cart and a table configuration includes disengaging the locking element from one of two gravity seats in the coupling member, pivoting each leg between a ground clearing position and a ground engaging position, and engaging the locking element in the other of two gravity seats in the coupling member.

### BRIEF DESCRIPTION OF THE DRAWINGS

The invention may be more completely understood in consideration of the following detailed description of various embodiments of the invention in connection with the accompanying drawings, in which:

FIG. 1 is a perspective view of an apparatus in accordance with the invention configured as a cart with wheels in a ground-engaging position;

FIG. 2 is another perspective view of the apparatus in accordance with the invention configured as a cart;

FIG. 3 is a side perspective view of the apparatus in accordance with the invention configured as a cart;

FIG. 4 is an end perspective view of the apparatus in accordance with the invention configured as a cart, depicting a drawbar and steering yoke;

FIG. 5 is an end perspective view of the opposite end shown in FIG. 4 of the apparatus in accordance with the invention configured as a cart;

FIG. 6 is an overhead perspective view of the apparatus in accordance with the invention configured as a cart;

FIG. 7 is a bottom perspective view of the apparatus in accordance with the invention configured as a cart;

FIG. 8 is a perspective view of the apparatus in accordance with the invention configured as a table with wheels in a ground-clearing position and with the drawbar folded underneath a chassis;

FIG. 9 is a further perspective view of the apparatus in accordance with the invention configured as a table in the configuration of FIG. 8;

FIG. 10 is a side perspective view of the apparatus in accordance with the invention configured as a table;

FIG. 11 is an end perspective view of the apparatus in accordance with the invention configured as a table;

FIG. 12 is an end perspective view of the opposite end than that shown in FIG. 11;

FIG. 13 is a bottom perspective view of an apparatus in accordance with the invention configured as a table;

FIG. 14 is a perspective view of the chassis in accordance with the invention;

FIG. 15 is a further perspective view of the chassis of FIG. 14:

FIG. 16 is a perspective view of the steering yoke in accordance with the invention:

FIG. 17 is a further perspective view of the steering yoke;

FIG. 18 is a perspective view of the drawbar bracket in accordance with the invention;

FIG. 19 is a perspective view of the drawbar in accordance with the invention;

FIG. 20 is a perspective view of a leg in accordance with the invention;

FIG. 21 is a perspective view of a right-hand oriented coupling member in accordance with the invention;

FIG. 22 is a further perspective view of the right-hand oriented coupling member of FIG. 21;

FIG. 23 is a perspective view of a left-hand oriented coupling member in accordance with the invention; and

FIG. 24 is a further perspective view of the left-hand oriented coupling member of FIG. 23.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives.

### DETAILED DESCRIPTION OF THE DRAWINGS

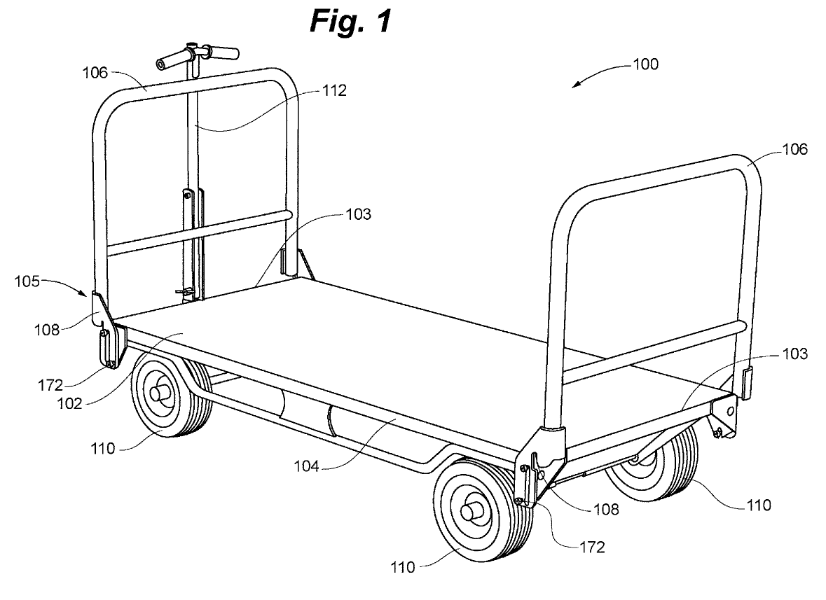

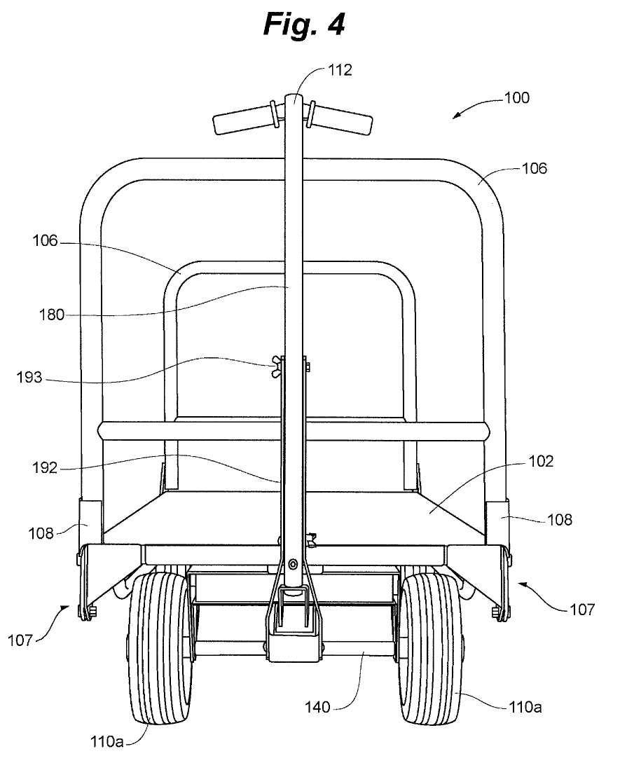

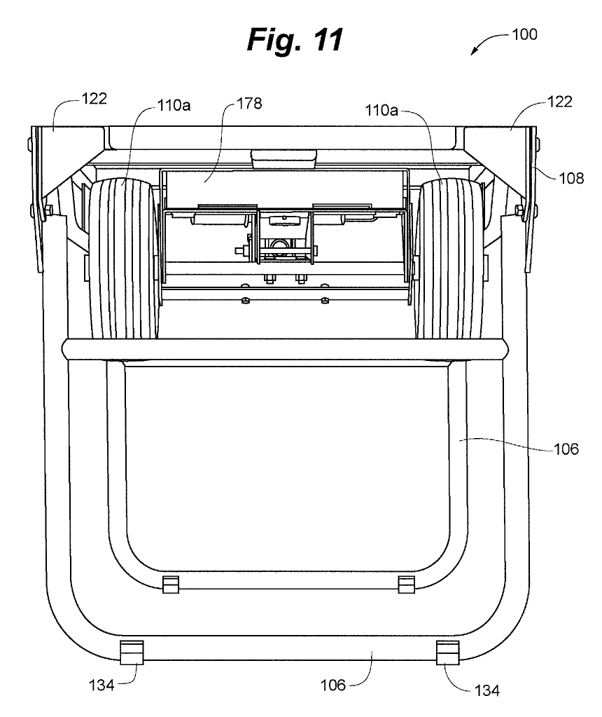

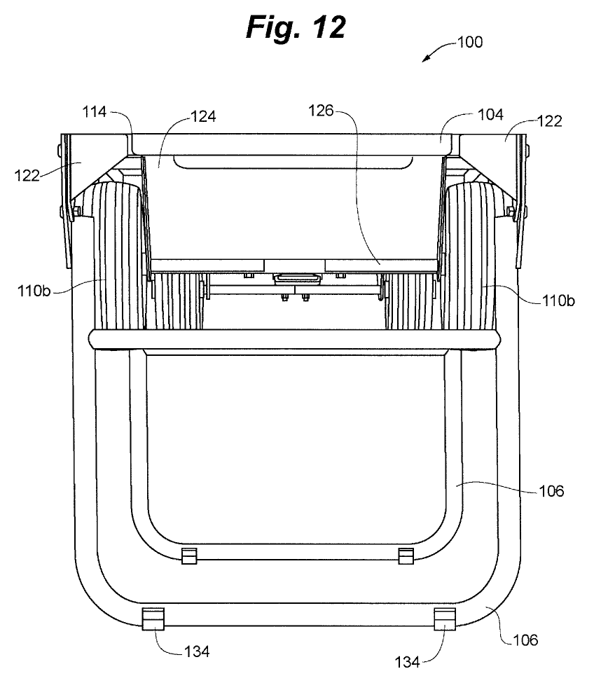

In one embodiment of the invention, as depicted in FIGS. 1-24, convertible cart 100 generally comprises a support surface 102 mounted to a chassis 104, a leg 106 operably coupled to each of generally opposing ends 103 of chassis 104, a coupling member 108 for selectively engaging leg 106 in a ground-engaging position or a ground-clearing position, at least two pneumatic or inflatable tires 110, and a steering mechanism 112.

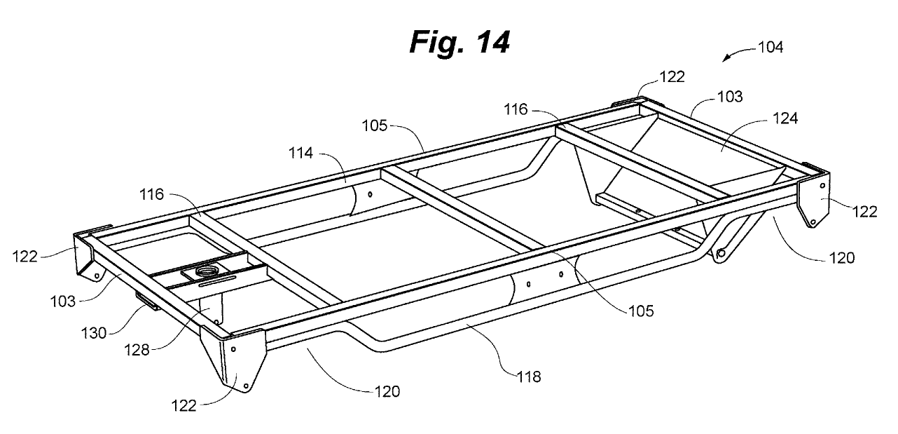

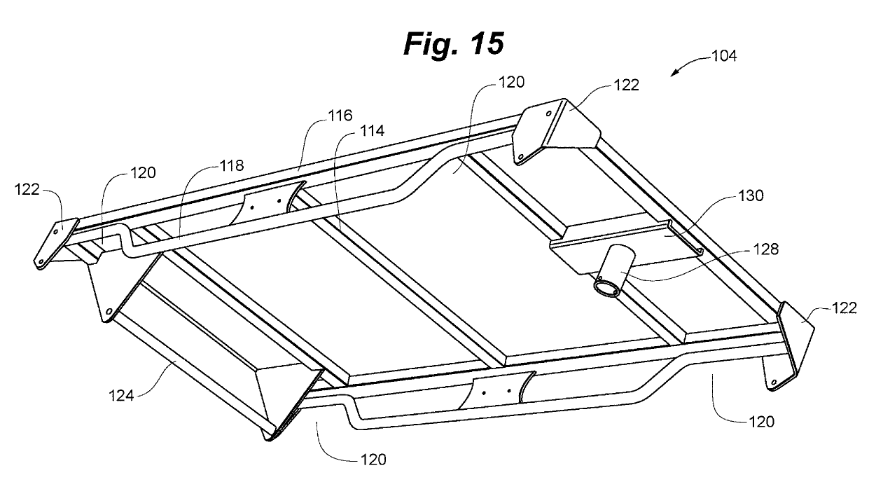

Referring to FIGS. 14 and 15, chassis 104 can comprise a generally rectangular frame 114, with at least one crossbar 116 for lateral support of frame 114. Chassis 104 further comprises generally opposing ends 103, and generally opposing sides 105. In various embodiments depicted and described herein, chassis 104 can be constructed of welded steel or aluminum. Chassis 104 can further include a tubular frame 118 extending along the length of frame 114. Tubular frame 118 can comprises indentations or cutouts 120 at each corner of chassis 104. Chassis 104 generally includes corner brackets 122 at each corner of frame 114.

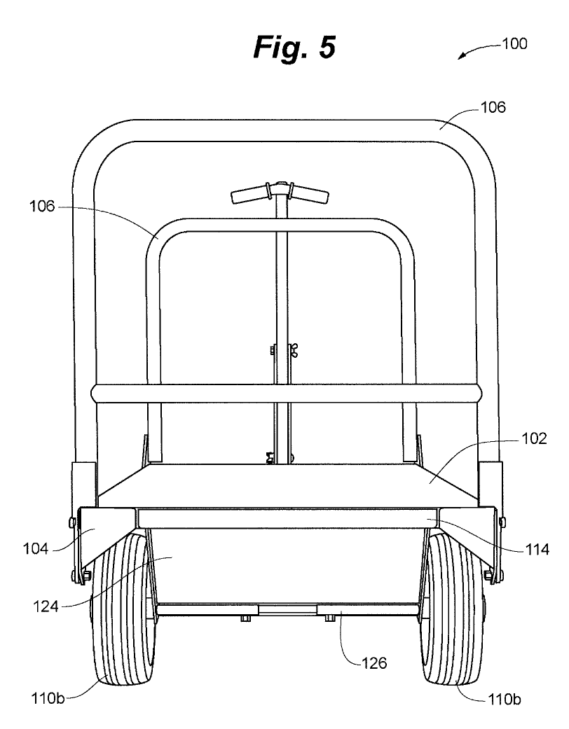

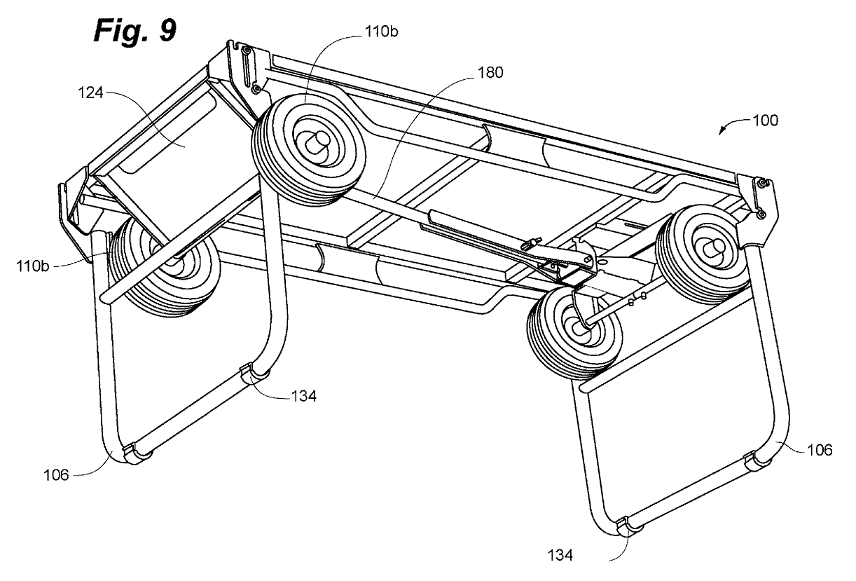

Referring to FIGS. 5, 7, 12 and 15, chassis 104 can further comprise a rear axle support panel 124 coupled to the rear side of frame 114. Rear axle support panel 124 operably couples rear axle 126 to the rear of frame 114 by extending downward from frame 114 to below a generally horizontal plane created by frame 114, between the rear of frame 114 and crossbar 116 as illustrated in FIGS. 9 and 15.

Referring to FIGS. 14 and 15, chassis 104 can also comprises pivot tube 128 supported by and extending from support member 130. Support member 130 is coupled to and extends between the front side of frame 114 and crossbar 116.

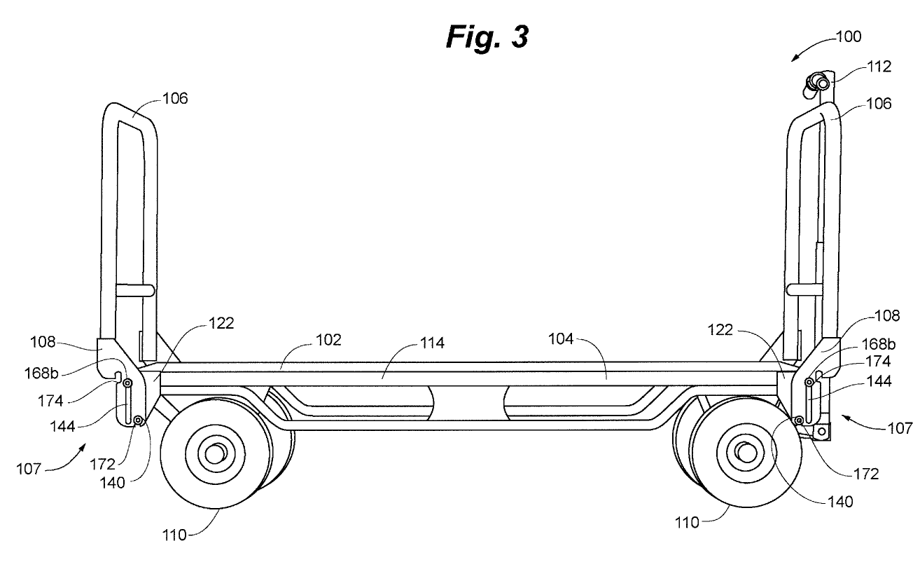

Referring to FIGS. 3 and 6-8, support surface 102 is mounted to chassis 104. Support surface 102 can be welded to chassis 104, or coupled by mechanical fastening, such as bolts, screws, wing nuts, and the like. Support surface 102 can be constructed from a polymer, laminated wood, or from a steel or aluminum skin.

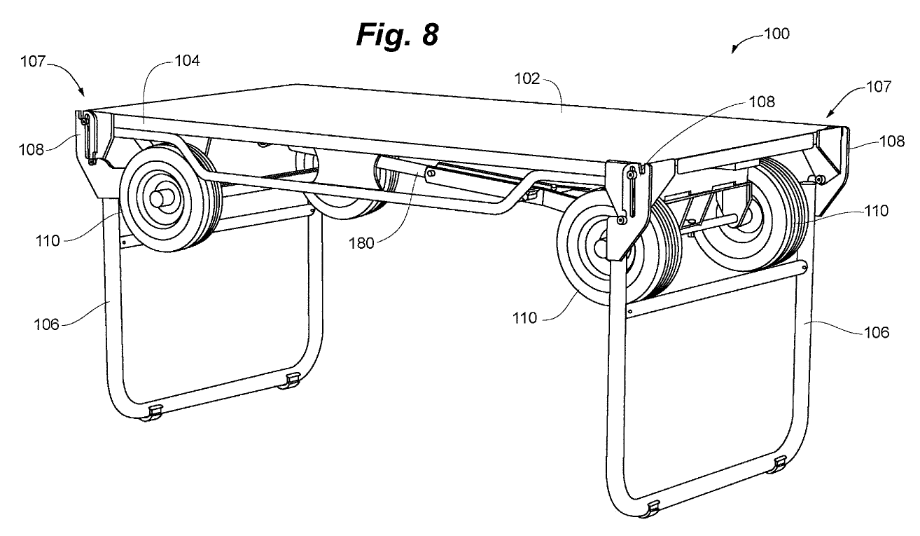

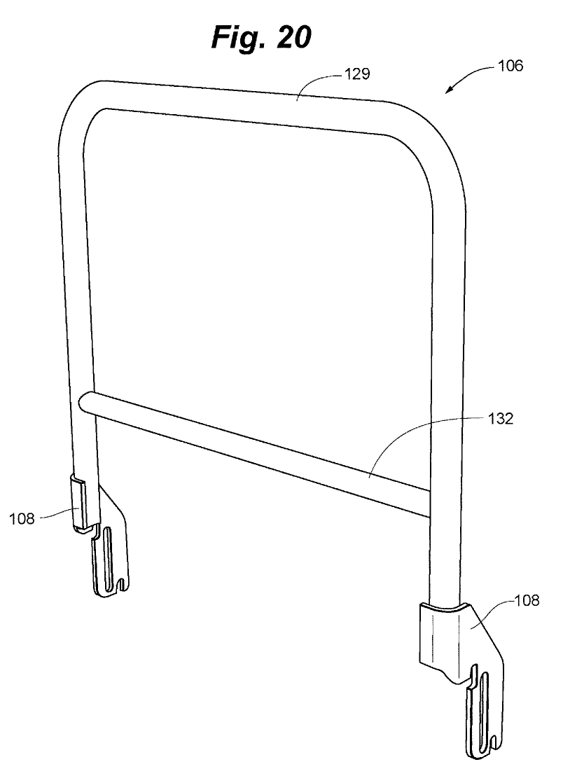

As depicted in FIG. 20, leg 106 generally comprises an inverted U-shape frame 129 optionally with at least one crossbar 132 for additional stability. Coupling member 108 can be secured to leg 106 by welding or mechanical fastening, such as locking elements, to each end of frame 129. Legs 106 and coupling members 108 can be constructed from steel, aluminum, or other suitable materials. Referring to FIGS. 8-13, leg 106 can further comprise at least one foot 134 near each corner of the inverted U.

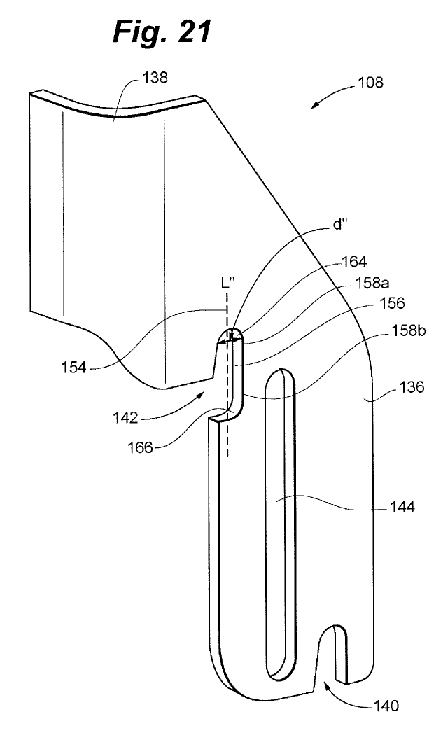

In one embodiment, as illustrated in FIGS. 21-24, coupling member 108 can comprise a generally planar structure 136 integrally connected to a generally curved coupling structure 138 adapted to receive leg 106. Planar structure 136 and curved coupling structure 138 form a substantially L-shaped coupling member 108. Planar structure 136 generally includes a first engagement portion 140 positioned proximate a first edge 137 of planar structure 136, a second engagement portion 142 positioned at an intersection of a second edge 139 of planar structure 136 and a bottom edge 141 of coupling structure 138, and an elongated slot 144 positioned towards the center of planar structure 136, each adapted to receive mechanical fasteners.

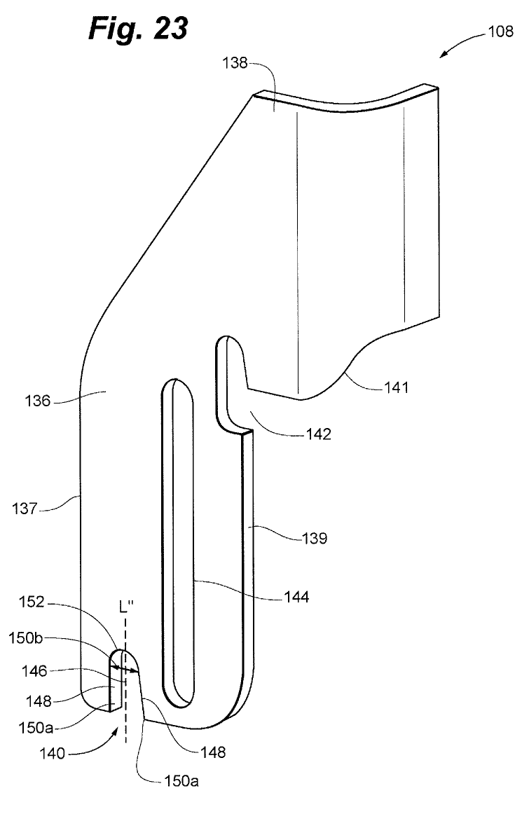

Referring to FIG. 23, first engagement portion 140 generally presents a substantially U-shaped indentation 146 with a longitudinal axis L. Indentation 146 has two generally planar walls 148 extending along axis L, each having a first end 150a and second end 150b, and joined by a substantially semicircular connecting wall 152 proximate second end 150b, having a diameter d. The distance between first ends 150a distal semicircular connecting wall 152 is greater than the diameter d, forming a “flared” U shape.

Referring to FIG. 21, second engagement portion 142 can generally present a substantially C-shaped indentation 154 with a longitudinal axis L″. Indentation 154 comprises a first planar wall 156 with first end 158a and second end 158b, and a second planar wall 160 with first end 162a and second end 162b. Planar wall 156 extends along L″, while planar wall 160 extends a distance less than L″. Substantially semicircular wall 164 connects first end 158a of planar wall 156 first end 162a of planar wall 160. Substantially ¼ circle wall 166 is proximate second end 158b of planar wall 156. The distance between planar wall 156 and planar wall 160 at the second end 162b of planar wall 160 is greater than the diameter d″ of semicircular wall 164, so that planar walls 156 and 160 are unparallel.

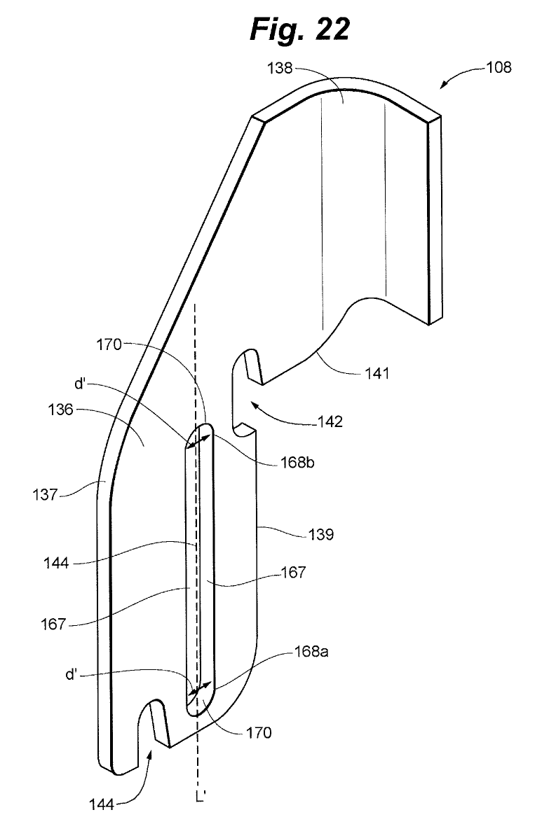

Referring to FIG. 22, elongated slot 144 comprises two generally planar parallel walls 167 extending along a longitudinal axis L′ with first end 168a and second end 168b. Semicircular wall 170 connects two planar walls 166 on each end, each semicircular wall 170 having an equal diameter d′. First engagement portion 140 is located proximate first end 168a of slot 144, while second engagement portion 142 is located proximate second end 168b of slot 144. Longitudinal axes L, L′, and L″ are substantially parallel to one another.

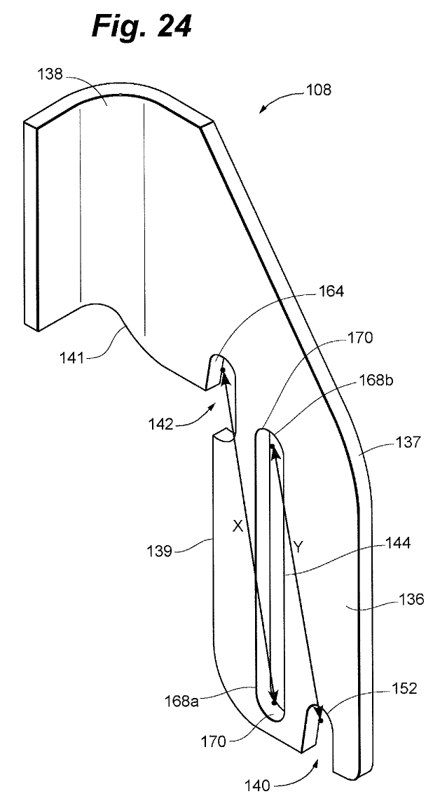

Referring to FIG. 24, a distance “x” between the center point of semicircular wall 164 and semicircular wall 170 at first end 168a of elongated slot 144 is substantially equal to a distance “y” between the center point of semicircular wall 152 and semicircular wall 170 at second end 168b of elongated slot 144.

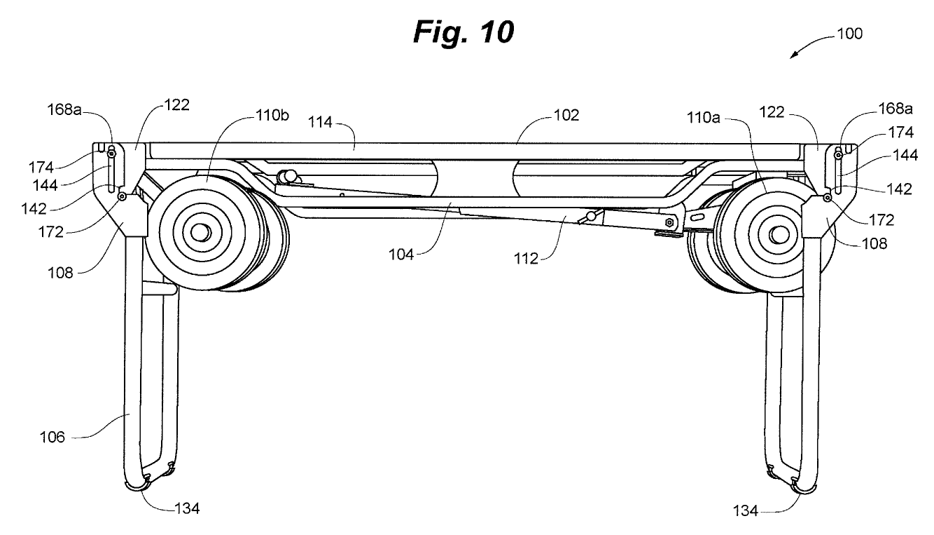

Referring to FIGS. 3 and 10, frame 114 includes a locking element 172, such as a pin, bolt, pivot shaft, and the like, carried in a static relationship on corner bracket 122 therewith, such that locking element 172 is engagable with either engagement portion 140 or 142 on coupling member 108. Frame 114 further includes pivot element 174, such as a pin, bolt, pivot shaft, and the like carried in a static relationship on corner bracket 122 positioned at a distance z from locking element 172. Pivot element engages with slot 144 at either first end 168a or second end 168b of slot 144 to secure coupling member 108 to corner bracket 122 of chassis 104.

In an alternative embodiment (not shown), coupling member 108 includes one or more locking elements 172 and pivot element 174 carried in a static relationship, and chassis 104 includes a first engagement portion 140 and second engagement portion 142, such that the one or more locking elements 172 of coupling member 108 engages with one of two engagement portion 140 or 142 of chassis 104.

At least one leg 106 of convertible cart 100 is operably coupled to chassis 104 by coupling mechanism 107. Coupling mechanism 107 generally includes coupling member 108, locking element 172, pivot element 174, and corner bracket 122.

As depicted in the Figures, cart 100 comprises a leg 106 operably coupled by coupling mechanism 107 to each end 103 of chassis 104. Coupling member 108 movably secured to corner bracket 122 of chassis 104 by pivot element 174. Legs 106 are shiftable between a ground-engaging position wherein the invention is configured as a cart, as depicted in FIGS. 1-7, and a ground-clearing position wherein the invention is configured as a table, as depicted in FIGS. 8-13.

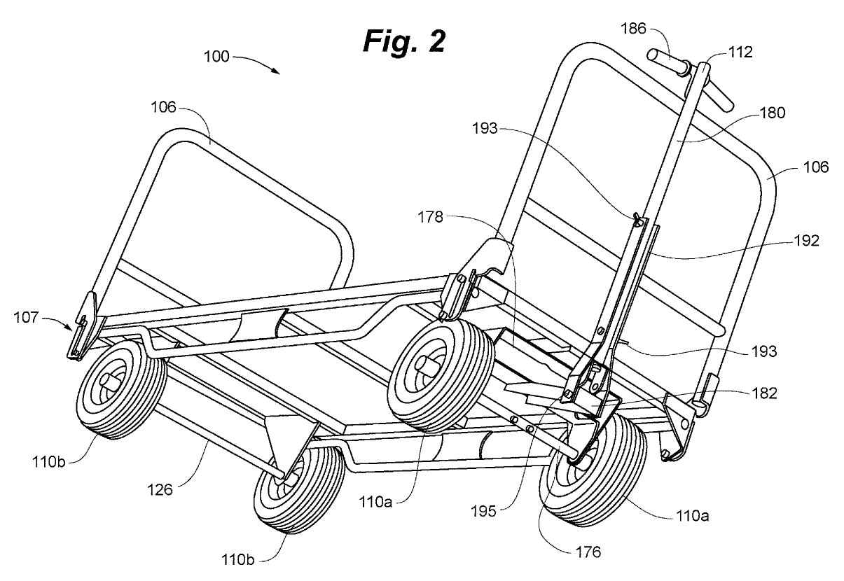

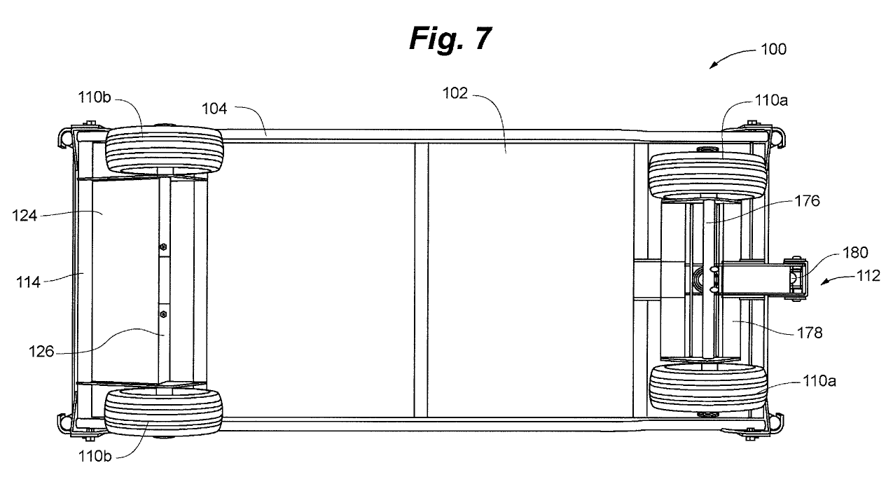

Referring to FIGS. 2 and 7, convertible cart 100 can include tires 110, such as pneumatic tires. Front tires 110a are operably coupled to front axle 176 and rear tires 110b are operably coupled to rear axle 126. In one embodiment of the invention, as best depicted in FIG. 7, front axle 176 has a length less than the length of rear axle 126. Front axle 176 and/or rear axle 126 can comprise a single component, or a plurality of components coupled by mechanical fasteners such as nut and bolts.

Referring to FIGS. 2, 4, and 13, cart 100 can further comprise steering mechanism 112, such as “radio flyer” steering wherein front axle 176 is rotatable about a centrally located point that can provide convertible cart 100 with further mobility outdoors and across grass and gravel, and zero radius turning.

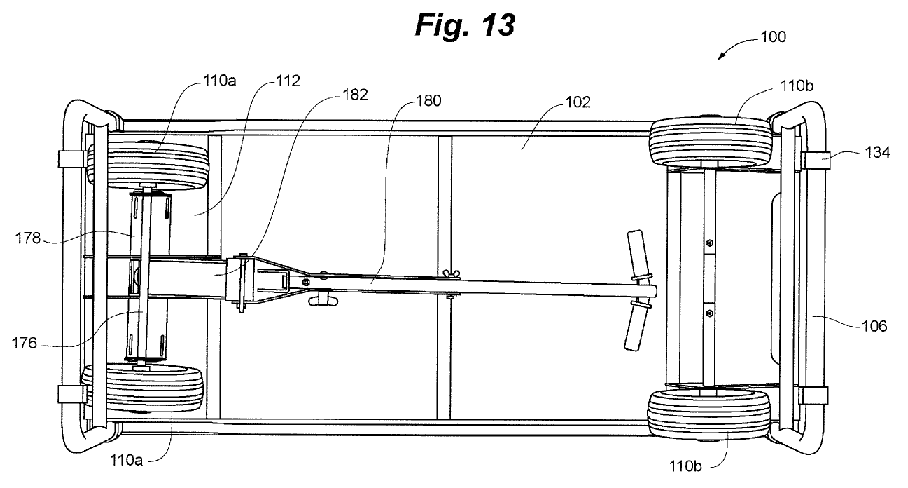

As illustrated in FIGS. 7 and 13, steering mechanism 112 generally comprises steering yoke 178 operably coupled to front axle 176, and drawbar 180 operably coupled to steering yoke 178. Steering yoke 178 and drawbar 180 can be constructed from steel, aluminum, or other suitable materials.

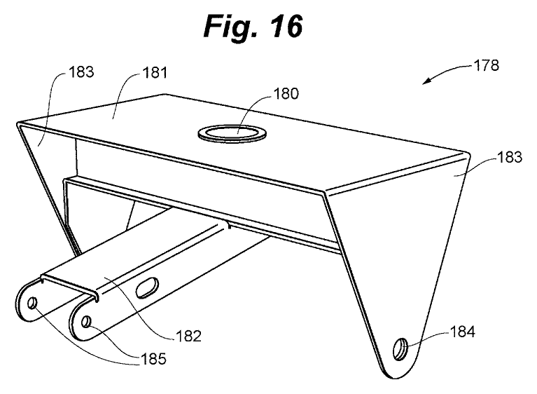

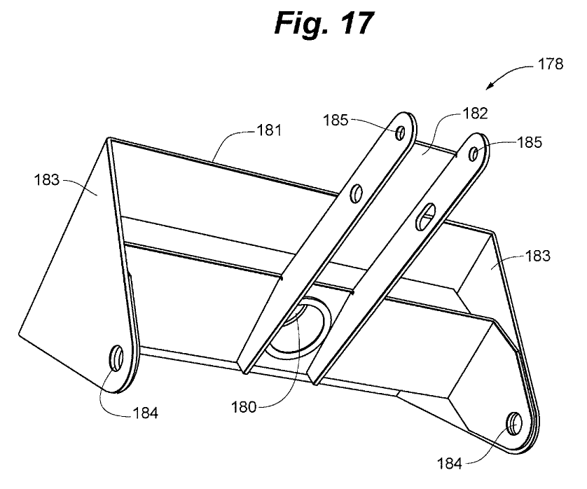

Referring to FIGS. 16 and 17, steering yoke 178 generally includes a planar plate 181 with central pivot aperture 180 adapted to engage pivot tube 128 of chassis 104, tongue 182 extending generally perpendicular to an axis extending laterally across plate 181, and two wings 183 extending vertically at a substantially right angle at each edge of plate 181. Wings 183 further comprise axle apertures 184. Front axle 176 passes through apertures 184 wherein front tires 110a and 11b are operably coupled to each end of front axle 176 on either side of yoke 178. Front axle 176 is rotatable about a substantially vertical axis within pivot tube 128. Cutouts 120 of tubular frame 118 of chassis 104 can provide clearance for tires 110a and 110b and/or drawbar 180.

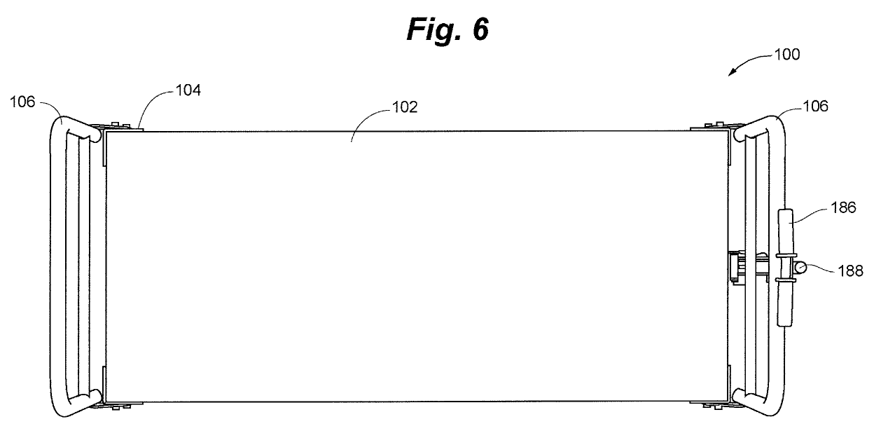

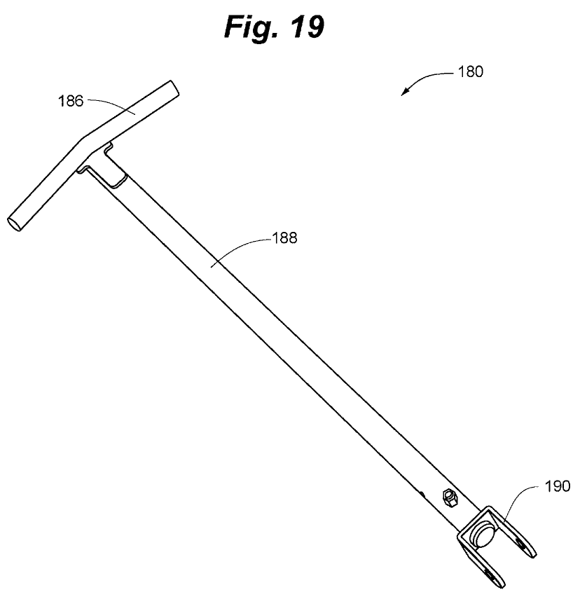

Referring to FIG. 19, drawbar 180 generally can comprise handle 186, shaft 188, and hitch bracket 190. Shaft 188 includes first and second generally opposing ends 181. Handle 186 is positioned proximate a first end 181a, and hitch bracket 190 is positioned proximate a second end 181b. Handle 186 can be substantially perpendicular to shaft 188, or angled to provide ergonomically comfortable configuration. As depicted in FIG. 6, handle 186 is generally not coplanar with shaft 188.

As depicted in FIG. 2, drawbar 180 is operably coupled to tongue 182 of yoke 178 by means of drawbar bracket 192 so that handle 186 is oriented distal from yoke 178. In an alternative configuration, not shown, drawbar 180 is coupled to yoke 178 so that hitch bracket 190 is oriented distal from yoke 178 and hitch bracket 190 can be used with a hitch pin to operably couple convertible cart 100 to motorized vehicles.

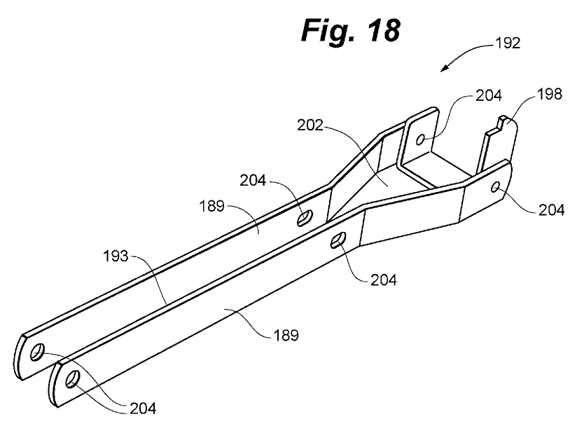

Drawbar bracket 192, shown in FIG. 18, generally comprises a planar plate 193 and sidewalls 189 positioned substantially perpendicular to plate 193 to create a recess 194 for receiving shaft 188 of drawbar 180. Shaft 194 can optionally widen to create neck 202. Drawbar shaft 188 rests within recess 194, whereas handle 186 rests above recess 194 and sidewalls 189 to allow positioning of drawbar 180 in either handle accessible or hitch bracket accessible orientation. Further depicted in FIG. 18, apertures 204 positioned along sidewalls 189 for receiving mechanical fasteners, such as wing nuts or pins. Drawbar 180 can be secured to shaft 188 by welding or mechanical fastening 195, such as by wing nuts and bolts, screws, pins, and the like, as depicted in FIG. 2.

Drawbar bracket 192 can further comprise a locking tab 198 for locking drawbar 180 in a desired position by engaging locking tab 198 on a portion of convertible-cart 100.

Drawbar bracket 192 is further removably secured to tongue 182 by mechanical fastening means 195, as illustrated in FIGS. 2 and 13. In an alternative embodiment (not shown,) drawbar 180 is secured directly to chassis 104 or front axle 176.

Drawbar 180 and drawbar bracket 192 can be foldable, such that drawbar 180 can be stowed underneath chassis 104 and support surface 102 when cart 100 is configured as a table. Locking tab 198 can be engaged with a portion of chassis 104.

It is an advantage of the present invention that no springs, removable bolts, or the like are needed to maintain convertible cart 100 in either the cart configuration or the table configuration. Rather, legs 106 are maintained in a ground-clearing position by gravity, such that the weight of legs 106 positively engages coupling member 108 and locking element 172, as depicted in FIG. 9. Locking element 172 rests in engagement portion 140, while pivot element 174 rests along second end 168b of slot 144.

Similarly, legs 106 are maintained in a ground-clearing position, by gravity, such that the weight of chassis 104, support surface 102, and items placed thereupon, positively engages coupling member 108 and locking element 172, as depicted in FIG. 1. Locking element 172 rests in engagement portion 142, while pivot element 174 rest along first end 168a of slot 144.

To convert the present invention from a cart as shown in FIGS. 1-7, to a table as shown in FIGS. 8-13, a user lifts up on a first leg 106, releasing leg 106 from its engagement with chassis 104 by releasing locking elements 172 from first engagement portions 140 of coupling members 108, and rotates leg 106 downward. The end of cart 100 is lifted by the user, and first leg 106 is moved into engagement with chassis 104, such that first leg 106 is in a ground-engaging position wherein locking elements 172 engage second engagement portions 142 of coupling member 108.

The user then lifts up on a second leg 106, releasing leg 106 from its engagement with chassis 104 by releasing locking elements 172 from first engagement portions 140 of coupling members 108, and rotates leg 106 downward. The end of cart 100 is lifted by the user, and said second leg 106 is moved into engagement with chassis 104, such that said second leg 106 is in a ground-engaging position wherein locking elements 172 engage second engagement portions 142 of coupling member 108, and convertible cart 100 is then configured as a table.

Optionally, drawbar 192 is rotated about an axis X of tongue 182 so that it is folded underneath chassis 104. Locking tab 198 then engages a portion of frame 114.

To convert cart 100 from a table back to a cart, a user lifts up on an end of cart 100, releasing first leg 106 from its engagement with chassis 104 by releasing locking elements 172 from second engagement portions 142 of coupling members 108, and rotates leg 106 upward, and lowers the end of cart 100 to the ground. Said first leg 106 is then moved into engagement with chassis 104, such that said first leg 106 is in a ground-clearing position wherein locking elements 172 engage first engagement portions 140 of coupling member 108.

The user then lifts up on the other end of cart 100, releasing second leg 106 from its engagement with chassis 104 by releasing locking elements 172 from second engagement portions 142 of coupling members 108, and rotates leg 106 upward, and lowers the end of cart 100 to the ground. Said second leg 106 is then moved into engagement with chassis 104, such that said second leg 106 is in a ground-clearing position wherein locking elements 172 engage first engagement portions 140 of coupling member 108, and convertible cart 100 is then configured as a cart.

In an alternative configuration of the invention that is not depicted, legs 106 can be folded flat on support surface 102 for storage. In yet another embodiment of the invention not depicted, a temporary support wall can be secured around the legs to provide support walls when in the cart configuration. For example, a mesh wrap can be secured by mechanical fastening means around the exterior of legs 106.

The invention may be embodied in other specific forms without departing from the essential attributes thereof; therefore, the illustrated embodiments should be considered in all respects as illustrative and not restrictive.

What is claimed is:

1. An apparatus convertible between a cart and a table, comprising:
a chassis;
a support surface operably carried by the chassis;
a ground engaging wheel operably coupled to the chassis;
a leg shiftable between a leg ground clearing position wherein the wheel is engageable with the ground to configure the apparatus as a cart, and a leg ground engaging position wherein the leg is engageable with the ground and the wheel clears the ground to configure the apparatus as a table;
a coupling mechanism operably, shiftably coupling the leg to the chassis, the coupling mechanism comprising a coupling member and a locking element, one of the coupling member and the locking element being carried by the chassis in static relationship therewith,
the coupling member including structure defining a first engagement portion for selectively fixedly engaging said locking element in a first gravity seat when the leg is in the ground clearing position, and the coupling member further including structure defining a second engagement portion for selectively fixedly engaging said locking element in a second gravity seat when the leg is in the ground engaging position.

2. The apparatus of claim 1, further comprising a pivot element slidably received in an elongated slot formed in the coupling member.

3. The apparatus of claim 2, wherein the first engagement portion is located proximate a first end of the elongated slot, and the second engagement portion is located proximate a second end of the elongated slot.

4. The apparatus of claim 3, wherein the first gravity seat is substantially U-shaped and the locking member is generally cylindrical.

5. The apparatus of claim 3, wherein the second gravity seat is substantially C-shaped and the locking member is generally cylindrical.

6. The apparatus of claim 3, wherein the pivot member is slidable from the first end of the elongated slot to the second end of the elongated slot and has a first center position at the first end of the elongated slot and a second center position at the second end of the elongated slot and the locking member has a third center position when it is received in the first gravity seat and a fourth center position when it is received in the second gravity seat and wherein a first distance between the first center position and the fourth center position and a second distance from the second center position and the third center position are substantially equal.

7. The apparatus of claim 1, further comprising a reversible drawbar operably couplable to the chassis, the drawbar comprising an elongated shaft, a handle proximate a first end of the shaft, and a hitch bracket proximate a second end of the shaft.

8. The apparatus of claim 7, wherein the drawbar is freely pivotable about a center and wherein the drawbar is positionable to be substantially vertical when the leg is in the leg ground clearing position, and wherein the drawbar is positionable to be substantially horizontally located below the support surface when the leg is in the leg ground-engaging position.

9. The apparatus of claim 7, wherein the drawbar is operably coupled to the chassis by a drawbar bracket into which the drawbar shaft is at least partially receivable and relative to which the drawbar can reversibly coupled.

10. The apparatus of claim 8, wherein the drawbar operably shiftable between two configurations, a first configuration wherein the handle is located distal from the chassis and available to be grasped for moving the apparatus and a second configuration wherein the hitch bracket is located distal from the chassis and available to be to be coupled to a prime mover to move the apparatus.

11. A method of shifting an apparatus between a first configuration as a cart to a second configuration as a table, the method comprising:
releasing a first leg of the cart from a first positional engagement with a chassis to which the first leg is operably coupled by releasing a first locking element from a gravity seat of one of two engagement portions of a first coupling member;
rotating the first leg between a ground-clearing position and a ground-engaging position;
engaging the first leg in a second positional engagement with the chassis by engaging the first locking element within a gravity seat of another of two engagement portions of the first coupling member.

12. The method of claim 11, the method further comprising:
pivoting a drawbar operably coupled to the chassis between a position extending outwardly from the chassis and a substantially horizontal position under a support surface coupled to the chassis.

13. The method of claim 11, the method further comprising:
placing athletic equipment on a support surface coupled to the chassis;
transporting athletic equipment between locations when the apparatus is configured in the first configuration as a cart; and
utilizing the support surface as a tabletop for placing items when the apparatus is configured in the second configuration as a cart.

14. An apparatus convertible between a cart and a table, comprising:
a chassis;
a support surface operably carried by the chassis;
a ground engaging wheel operably coupled to the chassis;
a leg shiftable between a leg ground clearing position wherein the wheel is engageable with the ground to configure the apparatus as a cart, and a leg ground engaging position wherein the leg is engageable with the ground and the wheel clears the ground to configure the apparatus as a table;
means for movably coupling the leg to the chassis, the means for movably coupling comprising means for gravitationally seating a locking element, one of the means for coupling and the locking element being carried by the chassis in static relationship therewith,
the means for gravitationally seating including first means for selectively fixedly engaging said locking element in a first gravity seat when the leg is in the ground clearing position, and the means for gravitationally seating including second means for selectively fixedly engaging said locking element in a second gravity seat when the leg is in the ground engaging position.

15. The apparatus of claim 14, further comprising a pivot element slidably received in an elongated slot formed in the means for movably coupling.

16. The apparatus of claim 14, further comprising a reversible drawbar operably couplable to the chassis, the drawbar comprising an elongated shaft, a handle proximate a first end of the shaft, and a hitch bracket proximate a second end of the shaft.

17. The apparatus of claim 16, wherein the drawbar is freely pivotable about a center and wherein the drawbar is positionable to be substantially vertical when the leg is in the leg ground clearing position, and wherein the drawbar is positionable to be substantially horizontally located below the support surface when the leg is in the leg ground-engaging position.

18. The apparatus of claim 16, wherein the drawbar is operably coupled to the chassis by a drawbar bracket into which the drawbar shaft is at least partially receivable and relative to which the drawbar can reversibly coupled.
